(19) United States
(12) Patent Application Publication
(10) Pub. No.: US 2023/0122874 A1
(43) Pub. Date: Apr. 20, 2023

(54) TECHNIQUES FOR IDENTIFYING QUOTATIONS IN IMAGES POSTED TO A FEED

(71) Applicant: Microsoft Technology Licensing, LLC, Redmond, WA (US)

(72) Inventors: Rishi Gupta, Bangalore (IN); Sakshi Verma, Haryana (IN); Bharat Kumar Jain, Hyderabad (IN); Vipin Gupta, Bangalore (IN)

(21) Appl. No.: 17/506,208

(22) Filed: Oct. 20, 2021

(51) Int. Cl. G06K 9/62; G06N 3/04; G06F 16/438; G06F 16/41

(52) U.S. Cl. CPC G06K 9/6215; G06F 16/41; G06F 16/438; G06K 9/6267; G06N 3/04; G06K 2209/01

(57) ABSTRACT

Described herein are techniques for using supervised machine learning to determine whether an image that has been posted to a feed of an online service includes a quotation. In some instance, supervised machine learning techniques are used to infer or predict an intent of a content poster in posting a content item to a feed of an online service. By better understanding the nature of the content being posted, various recommendations can be made during the time when an end-user is posting content, and thereafter.

### TECHNICAL FIELD

The present application generally relates to supervised machine learning techniques for use in classifying content that has been posted to a feed. More precisely, the present application describes machine learned classification techniques for use in determining whether text identified in an image posted to a feed is representative of a quotation, or quote, and in classifying an intent of the content poster in posting the image.

### BACKGROUND

Many online services facilitate the sharing of content through an application or service referred to as a feed - sometimes referred to as a news feed or content feed. Depending upon the nature of the online service and the community of people served, the nature and quality of the content that is posted to and presented via a feed will vary greatly. By way of example, many content postings shared via a feed involve or include content that has been generated by others. For instance, an end-user of an online service may share, via a feed, a news article that is being hosted on a third-party website. Many content postings shared via a feed may involve or include original, user-generated content. For example, end-users may utilize any of a wide variety of content creation applications and tools to create original content, such as photos, images, graphics, videos, and so forth, which are then shared via the feed of an online service. One particularly common type of content that is posted and shared to a feed is referred to as an Internet meme, meme image, or simply (and hereafter), a meme. A meme is typically an image that has been enhanced with some text, generally relating to something of cultural significance and intended to be rapidly and broadly shared.

For a variety of reasons, it is critically important that the operator of any online service understand the content that is being posted to and shared via a feed. For instance, some content may be inappropriate and/or undesirable (e.g., SPAM, political content, inflammatory content), or worse, some content may be unlawful. In the context of an online service that is serving a community of professionals, it may be undesirable to allow the posting and sharing of low-quality content, such as some memes. However, whereas some memes may be characterized as low-quality, others may be generally desirable for various reasons. For example, a meme may include a quotation that is inspirational, motivational, educational, or otherwise intended to spread awareness and positivity. Such a meme may be deemed perfectly suitable for presenting via the feed. A meme with a generally positive message may also be posted or shared by a famous or highly influential person, and again, may be deemed suitable for presentation via the feed, in part based on the source of the content. Accordingly, many online services utilize a variety of automated software-based content analysis tools and services designed to analyze content and classify the content, with the aim of identifying and allowing desirable content to be presented, while excluding content deemed to be harmful or objectionable.

### BRIEF DESCRIPTION OF THE DRAWINGS

Embodiments of the present invention are illustrated by way of example and not limitation in the figures of the accompanying drawings, in which:

FIG. 1 is a user interface diagram illustrating an example of a user interface for a feed, via which a user may post a meme, consistent with embodiments of the present invention;

FIG. 2 is a user interface diagram illustrating an example of a meme that has been posted to a feed, and the imperfect results of an optical character recognition operation performed on the meme, according to some embodiments of the invention;

FIG. 3 is a diagram illustrating an architectural model and corresponding data processing pipeline used in processing an image (e.g., a meme) that has been posted to a feed, consistent with embodiments of the invention;

FIG. 4 is a diagram illustrating an example of a user interface that may be used during a crowd sourcing task, during which a content posting is annotated for purposes of training a machine learning model, consistent with embodiments of the invention;

FIG. 5 is a diagram illustrating an architectural model and corresponding data processing pipeline used in processing a content posting for purposes of classifying an intent of the content poster in posting the content item, consistent with embodiments of the invention;

FIG. 6 is a block diagram illustrating a software architecture, which can be installed on any of a variety of computing devices to perform methods consistent with those described herein; and

FIG. 7 illustrates a diagrammatic representation of a machine in the form of a computer system within which a set of instructions may be executed for causing the machine to perform any one or more of the methodologies discussed herein, according to an example embodiment.

### DETAILED DESCRIPTION

Described herein are methods and systems for leveraging supervised machine learning techniques to identify quotations (e.g., text) within images that have been posted to a feed of an online service, and then in some instances, to classify an end-user’s likely intent or motivation for sharing a quotation. By identifying content that includes quotations and determining a likely intent of a person posting the content, intelligent decisions can be made concerning the content. In the following description, for purposes of explanation, numerous specific details and features are set forth in order to provide a thorough understanding of the various aspects of different embodiments of the present invention. It will be evident, however, to one skilled in the art, that the present invention may be practiced and/or implemented with varying combinations of the many details and features presented herein.

Several techniques exist for identifying quotations within text. However, in contrast with the inventive subject matter described herein, existing techniques generally attempt to identify a particular portion of text that represents a quotation within a larger collection of text — for example, within a news article, a document, or a book. As such, these existing techniques operate on input that exists natively as text — that is, data encoded to represent characters. As described herein and consistent with various embodiments of the present invention, a technique is provided to determine whether text included in an image posted to a feed is a quotation. Identifying quotations within images posted to a feed is technically challenging for a number of reasons. First, before a decision can be made as to whether certain text is a quotation, the text itself must be identified within the image. This is generally achieved through a process referred to as optical character recognition (OCR). While many implementations of OCR applications have a high rate of accuracy when processing certain images that consist entirely of text (e.g., images of documents), using OCR applications to identify portions of text within an image, such as a meme, frequently results in a less than perfectly accurate detection and recognition of the actual text. For instance, a number of factors may cause problems with the accuracy of identifying and recognizing text, including variable font sizes and styles, cluttered backgrounds overlapping the text within an image, and not properly accounting for breaks in the text. Accordingly, when performing OCR on an image, certain letters in the text or even entire words may not be correctly detected and recognized, leading to misspelled and/or unrecognizable words.

Another technical challenge in identifying quotations within images of a feed arises as a result of some quotations including the name of the person to whom the quote is attributed, while others do not. A related problem arises when the text included with an image is a quotation, but misidentifies the proper person to whom the quotations is or should be attributed. Finally, in some instances, additional text — that is, beyond that which represents the quotation — may be included within the image. All of these issues make it technically challenging to develop automated, software-based techniques for accurately determining whether an image posted to a feed includes a quotation.

Consistent with embodiments of the present invention, supervised machine learning techniques are utilized to identify quotations within images that have been posted to a feed. First, during a training phase, an appropriate training dataset is obtained. In some instances, one or more existing, annotated (e.g., labeled) collections of known quotations may be leveraged as training data. However, in other instances, training data may be obtained through crowdsourcing, by expert annotation, or similar techniques. Using the training dataset, each individual quotation in the training dataset is processed to generate for the quotation a vector representation. The vector representations of the collection of known quotations are then arranged to form a search index. For example, with some embodiments, the search index may be formed as a hierarchical, navigable small-world graph, to facilitate approximate nearest neighbor searching.

During the inference stage, an image that has already been posted to the feed, or an image that is currently in the process of being posted as part of a content item to the feed is first processed with an OCR application to identify and recognize text included within the image. The identified text is then processed to generate a vector representation of the text. The vector representation of the text, as detected in the image, is used as input to an approximate nearest neighbor search engine or algorithm, during which the vector representation of the text is compared with one or more vector representations of known quotations. Specifically, a similarity metric or matching score (e.g., Euclidian distance, Cosine distance, or some other metric) is derived for the vector representation of the text extracted from the image and one or more vector representations of known quotations in the search index. If the similarity metric or matching score for the text obtained from the image and some known quotation exceeds some predetermined threshold, indicating that the text obtained from the image is sufficiently similar to the known quotation, the image that contained the text may be classified as having or including a quotation, and thus being suitable for presentation via the feed. Alternatively, if the similarity metric does not exceed the predetermined threshold, the image containing the text may be classified as not including a quotation.

Advantageously, the text of an image may be properly identified as a quotation, even when the OCR process used to recognize the text is imperfect and includes one or more errors. Because the text of a quotation is converted to a vector, and because and the similarity metric or matching score is based on a vector comparison, it is not required that the actual text recognized during the OCR operation be an exact match of the text of any known quotation, in order for a quotation to be properly identified. Consistent with some embodiments, when the similarity metric or matching score exceeds the predetermined threshold, before classifying the image as containing a quotation, a secondary check may be performed. For example, with some embodiments, the edit distance between the text obtained from the image and the text of a known quotation may be calculated. If the edit distance is below some predefined threshold, the image may be classified as including a quotation. However, if the edit distance is greater than the predefined threshold, the image may be classified as not including a quotation.

Consistent with some embodiments, when the similarity metric or matching score falls below the predetermined threshold, but within some pre-defined mid-range, the text obtained from the image may be analyzed for the presence of a name associated with a known author or person. If the text obtained from the image includes the name of an author or person whose name is included in a list of known authors associated with known quotations, then the image may be classified as containing a quotation.

The above-described approach to identifying quotations is advantageous as it is generally independent of any particular OCR algorithm. That is, the technique will work with any of a variety of OCR applications and does not require that the OCR application recognize text within an image at one-hundred percent accuracy. However, as a supervised machine learning approach that relies on an annotated training dataset, the approach described above may not be as useful in identifying entirely new quotations that differ significantly from any included in the training dataset.

Accordingly, consistent with some alternative embodiments of the invention, a supervised machine learning model is trained and then used to classify an intent of a person posting a content item, including a meme or other image. Consistent with this second approach, a training dataset is obtained by identifying and obtaining content items posted to a feed that include memes or similar images. This collection of content items is then annotated by experts using a crowdsourcing technique. The experts, for example, annotate each instance of a content item to include information indicating 1) whether the image of the content items is a meme, 2) whether the image includes a quotation, 3) whether the text included within the image identifies an author or speaker of the quotation, and 4) one or more intents. Here, an intent is a reason for which the person has posted the content. For instance, when annotating the content item, the intent may be selected from a list of known intents, to include: motivational and/or inspirational; humor and/or sarcasm; religious; news; sharing an achievement, knowledge, awareness and/or opinion; seeking help; greetings; event announcement; marketing or selling a product or service; a job opportunity; and, seeking a job opportunity; and others. This list of intents is of course provided as an example, and in any particular embodiment, other known intents may be used in classifying a content item.

Using the annotated content items (e.g., the images) and a variety of other features associated with each individual content item in the training dataset, a machine learning model is trained to generate an output that indicates the likelihood that a content item has been posted with a particular intent. By way of example, the additional features used to train the machine learning model may include visual features derived from the image, textual features from text recognized from the image using an OCR application, recognized entity features derived from analyzing the text to identify named entities (e.g., the author or speaker of a quotation), and features derived from various social gestures (e.g., likes, comments, shares, etc.) associated with the content item as posted to the feed. Other features may include any comments associated with the content item, including metadata such as hashtags (e.g., “#topic”). The machine learning model — a type of multi-modal intent classifier — may be implemented as a gradient boosted decision tree model, such as XGBoost, or alternatively, the model may be a deep neural network, such as a convolutional neural network (CNN).

Consistent with some embodiments, the output of the intent classifier is a score for each of the several known or predefined intents. When a score associated with a particular intent exceeds a predetermined threshold, one or more status fields associated with a content item are updated to reflect the predicted intent of the content item, and to indicate that the content item has been cleared for presentation via the feed. Other advantages and benefits of various embodiments of the present inventive subject matter will be readily apparent from the description of the several figures that follows.

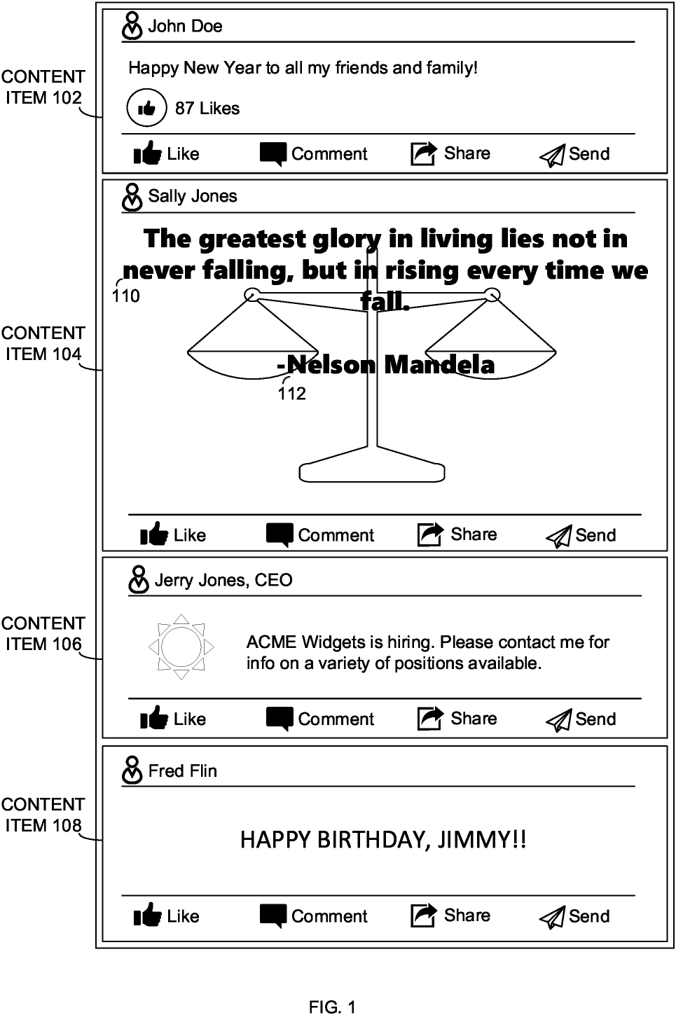

FIG. 1 is a user interface diagram illustrating an example of a user interface for a feed, via which a user may post a meme, consistent with an embodiment of the present invention. As illustrated in FIG. 1, the user interface of the feed includes four distinct content items that have been posted to, and presented via, the feed (e.g., content items 102, 104, 106 and 108). In this example, the content item with reference number 104 is a meme that includes a quote 110 from a famous person. In this case, the name of the person, Nelson Mandela 112, is included with the quote within the image.

As shown in FIG. 1, each content item is presented with various user interface elements that represent social actions or gestures that an end-user can take with respect to a particular content item. For example, an end-user may select a button or icon to “like” a content item. Additionally, an end-user may select a button or icon to comment on a content item, share a content item to the feed, and/or send a content item directly to one or more end-users via a direct messaging service. Consistent with some embodiments, these social actions or gestures can be detected and logged, and then subsequently used as training data for training a model to predict an intent of an end-user in posting a content item.

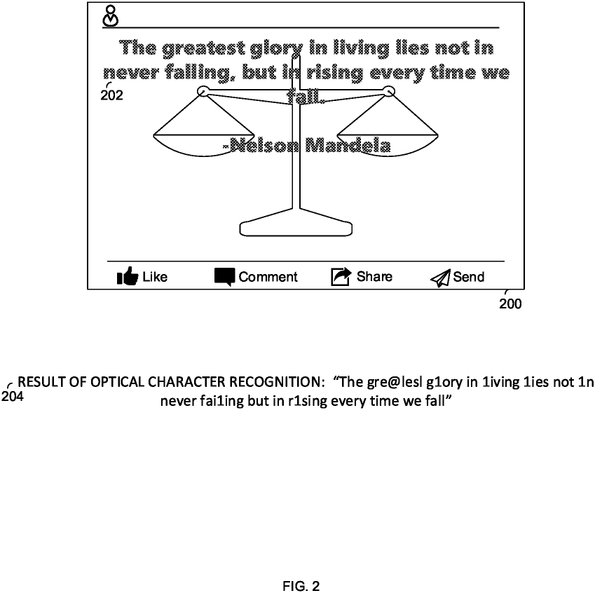

FIG. 2 is a user interface diagram illustrating an example of a meme 200 that has been posted to a feed, and the imperfect results 204 of an optical character recognition (OCR) operation, according to some embodiments of the invention. Consistent with some embodiments of the invention, subsequent to training a machine learning model to either identify quotations within an image, or classify an intent of an end-user in posting a content item, the trained machine learning model will be used to generate an output indicating whether an image includes a quotation, or alternatively, indicating a predicted intent of an end-user in posting a content item. In both instances, one of the inputs to a machine learning model will be text recognized within the image of the content item. Accordingly, consistent with embodiments of the invention, an optical character recognition (OCR) application is used to recognize text within the image. For various reasons, the result of the OCR application may not be perfect. For example, as illustrated in FIG. 2, the results 204 of the OCR application as applied to the original quotation 202 in the image are shown to include several errors. These errors arise due to a variety of reasons, including variable font sizes and styles, cluttered backgrounds overlapping the text within an image, and not properly accounting for breaks in the text. With some embodiments, because the resulting text 204 is processed to generate a vector representation of the text, a matching quotation from the search index may be identified, regardless of the errors that occur during the OCR process. In other embodiments, the resulting text from the OCR application may be provided as an input to a pre-trained model that outputs corrections to the text.

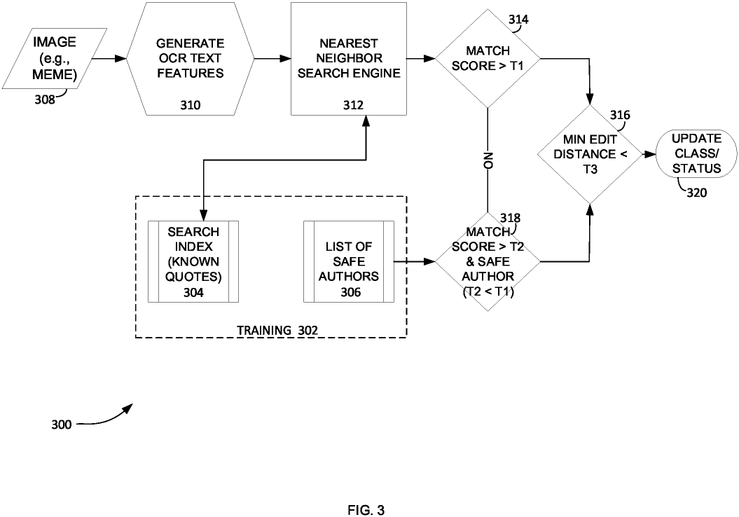

FIG. 3 is a diagram illustrating an architectural model 300 and corresponding data processing pipeline used in processing an image (e.g., a meme) that has been posted to a feed, consistent with embodiments of the invention. Consistent with some embodiments, a supervised learning technique is used to identify quotations within images that have been, or, are currently being, posted to a feed of an online service. Generally, the process involves two stages. During the first stage (e.g., the training stage 302), a collection of known quotations is obtained. For example, in some instances, one or more existing sets of known quotations may be leveraged. In other instances, content items that were previously posted to the feed may be identified and presented to subject matter experts who will extract the exact text to identify the existing quotations. In either case, the training dataset involves the full text of one or more collections of quotations with known authors.

Next, from this collection of known quotations, a search index 304 is generated for performing approximate nearest neighbor (ANN) searches. To generate the search index, each quotation is first processed to generate a vector representation of the quotation based on word embedding techniques. With some embodiments, the vector representation of a quotation is generated by, optionally, first processing the text of a quotation to remove certain characters (e.g., numbers, punctuation marks, etc.), and to convert all characters to lower case. With some embodiments, the vector representation is derived using what is known as a bag of words (BoW) technique, while also applying the term frequency and inverse document frequency (TF-IDF). In alternative embodiments, a type of machine learning model known as a Transformer encoder (e.g., pre-trained) may be used to process the text of each quotation to generate the embedding or vector representation of the quotation. Once the vector representation of each quotation has been derived, the vector representations are arranged in a search index to facilitate the efficient searching of the quotations using an approximate nearest neighbor (ANN) search algorithm. For instance, with some embodiments, the search index may be a hierarchical, navigable, small-world graph, (HSNW) which provides for an efficient and quick retrieval of “k” vector representations of quotations most similar to an input vector representation. Of course, other types of search indices may be used.

As illustrated in FIG. 3 with reference number 306, in addition to generating a search index, the collection of known quotations may be used to derive a list of known names (e.g., authors, or speakers) to which quotations are attributed. Accordingly, as described below, this list of known names may be used in certain instances to verify that text extracted from an image is representative of a known quotation as a result of matching some portion of text extracted from the image with a name in the list 306.

The second stage, what is commonly referred to as the inference stage or inference time, involves processing an image 308 that has been posted to the feed, or has been submitted for posting to the feed, in order to determine whether the image includes text that is a quotation. Accordingly, as shown in FIG. 3, the input to the model architecture 300 is an image 308. The image 308 may be one that has already been posted to the feed. Alternatively, the image 308 may be processed at the time an end-user is initially submitting the image for posting to the feed.

In any case, the first step 310 involves processing the image to derive text features - specifically, a vector representation of the text recognized within the image. Accordingly, the first step involves applying an optical character recognition (OCR) application to the image to recognize text (e.g., words) within the image. With the result of the OCR application, the recognized text is further processed to generate a vector representation of the resulting text. The processing of the text to generate the vector representation is achieved in the same manner as described above in connection with the technique for deriving a vector representation from a known quotation.

Next, the vector representation of the text recognized within the image 308 is used as an input to an approximate nearest neighbor (ANN) search engine 312. The search engine 312 uses the vector representation of the text recognized within the image 308 as input to identify within the search index 304 the vector representation of the known quotation that is most similar to the vector representation of the text extracted from the image. Specifically, the search engine returns a match score that is based on a similarity metric that is derived based on a calculation of a distance between the input vector and a vector in the search index. The similarity metric may be, or may be derived from, any one of a number of distance metrics to include the Euclidean distance, Cosine distance, or inner product of the two vectors. Of course, use of other similarity metrics are possible.

Once the search engine has returned a match score, the match score is compared 314 to a first predetermined threshold (“T1”) to determine whether the text recognized in the image is sufficiently similar to the text of a known quotation. For example, if the value of the match score meets or exceeds the first predetermined threshold, the text obtained from the image is determined to be sufficiently similar to a quotation represented by a vector in the search index 304. Consistent with some embodiments, when the match score is determined to meet or exceed the first predetermined threshold, a verification operation may be performed. For example, as shown with reference number 316, when the match score exceeds the first predetermined threshold, the character edit distance may be determined for the text recognized within the image and the text of the quotation associated with the vector representation upon which the match score is based (e.g., the known quotation determined to be most similar to the text obtained from the image 308). If the edit distance is lower than a predetermined threshold (“T3”), the text from the image is determined to be a quotation, and a status field associated with the image is updated to reflect that the image includes a quotation that is suitable for presentation via the feed.

If the match score is less than the first predetermined threshold (e.g., comparison with reference number 314), but the match score exceeds a second predetermined threshold, the text obtained from the image may be analyzed 318 to determine whether the text includes the name of a person associated with a known quotation and present in the list of known authors. Accordingly, if the match score is sufficiently high to meet or exceed the second predetermined threshold, without exceeding the first predetermined threshold, and the text includes the name of a person in the known author list, the text is determined to include a quotation, and a status field is updated accordingly.

When the text is determined to include a quotation, a status field associated with the image may be updated to indicate a particular status (e.g., cleared) of the image. For instance, when an image has a particular status (e.g., cleared) this may mean that the image is suitable for presentation via the feed. Alternatively, another status may indicate that the image is not suitable for presentation via the feed, or needs further analysis. In various embodiments, the output that results from the analysis may be captured with differing values for the status field or status fields. For example, in some instances, the end result of the analysis may involve setting a status field with a binary value (e.g., Yes, or No) to indicate whether a quotation was identified, or not, in combination with a confidence score. Similarly, with some embodiments, a separate status field with a binary value may be used to indicate whether an author was identified, or not, along with a confidence score.

While the architecture described above advantageously facilitates a technique for identifying images that include quotations, and thus aides in determining whether content items are suitable for presentation via a feed, alternative embodiments of the invention provide additional benefits in classifying the intent of an end-user who is posting, or has posted, a content item to the feed. Accordingly, consistent with some embodiments and as described in greater detail below, when an end-user is posting a content item to the feed, an image included with the content item may be processed by a machine learning model that generates an output indicating a predicted intent of the content poster, based at least in part on text included within the image of the content item. This information can be used to make a recommendation to the person posting the content. For instance, during the process of preparing a content item for posting, the end-user may be provided with a recommendation that the content item be tagged with metadata (e.g., with a hashtag) that best represents the nature or character of the content item. This may increase the number of persons who view the content item as the tag can be used in targeting end-users to whom the content item is presented, and the tag may assist in providing search results when content items are searched by an end-user. Accordingly, consistent with some embodiments, a machine learning model may be used to classify an intent of a person posting a content item.

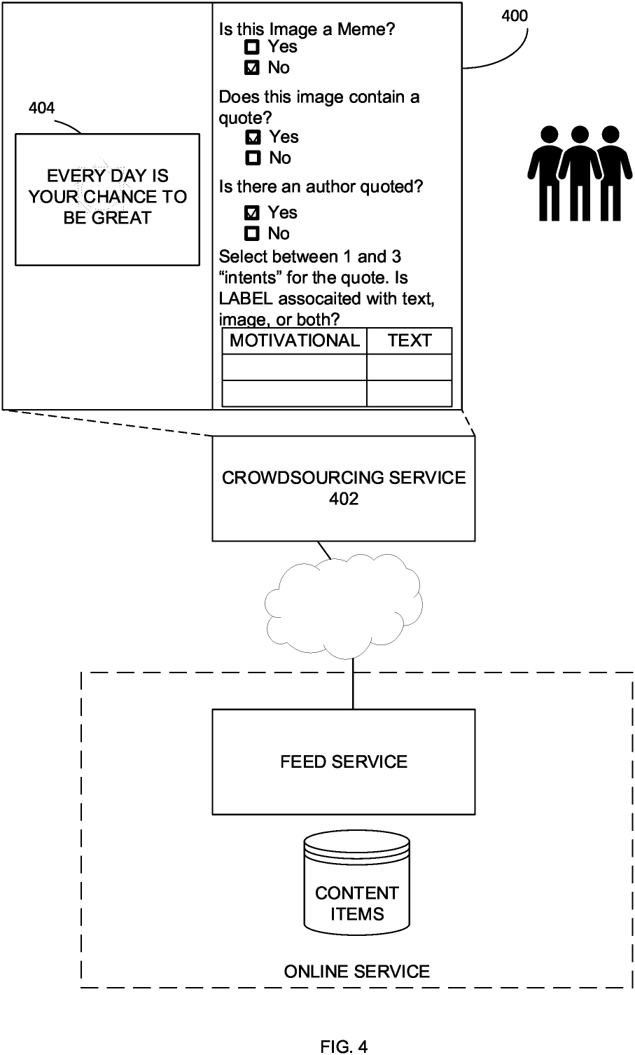

In order to properly train an intent classifier, training data is first obtained. FIG. 4 is a diagram illustrating an example of a user interface 400 that may be used during a crowdsourcing task, during which a content posting is annotated for purposes of deriving training data for training a machine learning model, consistent with embodiments of the invention. As illustrated in FIG. 4, as part of a crowdsourcing task, a crowdsourcing service 402 presents an image 404 associated with a previously posted content item to a subject matter expert, who is then prompted to provide information concerning the image 404. Specifically, as indicated in FIG. 4, the image 404 is shown, and the viewer is prompted to indicate whether the image 404 represents a meme, whether the image 404 includes a quotation, and whether the quotation includes the name of a person to whom the quotation is attributed. In addition, the viewer is prompted to specify an intent of the person posting the content item. The viewer may be prompted to select from a list of pre-defined intents, which are certainly not limited to, but may include:
Motivational/Inspirational
Humor
Sarcasm
Religious
Shared Job Opportunity
Seeking Job Opportunity
News
Shared Knowledge
Awareness
Share Opinion
Seeking Help/Support
Share Achievement
Personal Relationships/Love
Greetings
Greetings for Event or Occasion
Work from home
Thanks or Congratulations
Marketing or Selling a product or service

The information that is provided during the crowdsourcing task is then utilized as annotated training data and combined with a variety of additional features to train a machine learning model to predict an intent associated with a content item.

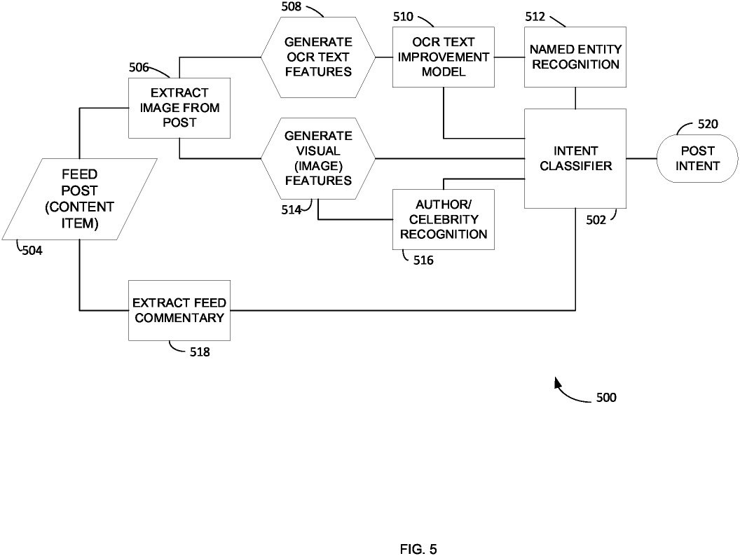

FIG. 5 is a diagram illustrating an architectural model 500 and corresponding data processing pipeline used in processing a content posting for purposes of classifying an intent of the content poster in posting the content item, consistent with embodiments of the invention. During a training stage, the model represented in FIG. 5 as the intent classifier with reference number 502, is first trained using a variety of features that comprise a training dataset. By way of example, the training dataset may include a variety of information associated with an individual content posting, including an image that is part of the content posting. Additional features used in training the intent classifier may include various visual features derived from the image itself. For instance, visual features used in training the intent classifier may include any of the following: the size of the image, the colors of the image, the variety in colors used in the image, the percentage of the image over which text is positioned, as well as the position within the image of the text. Other visual features may include features derived from various pre-trained and fine-tuned models that are used to understand the image, such as Inception V3, EfficientNet, an/or ResNet 50. In addition to visual features derived from the image, textual feature derived from any text recognized within the image may be used as features for training the intent classifier. Accordingly, with some embodiments, an OCR application is used to recognize text included within the image. Features (e.g., word embeddings), based on the recognized text may be derived using pre-trained models, such as a Transformer encoder (e.g., based on BERT), Global Vectors for Word Representations (GloVe), or techniques based on Bag of Words and TF-IDF. The text features are then provided as training data to train the intent classifier. With some embodiments, both the image and the text may be analyzed as part of a named entity recognition process to identify any named entities - particularly, names of persons to whom a quotation has been attributed. This information is included as a feature for training the intent classifier. Finally, various social signals or gestures may be included as features in training the intent classifier 502. These social signals include, but are not limited to, comments made by other end-users concerning the content posting, as well as user profile attributes of any user providing a comment on a content posting.

The machine learning model itself may be based on any of a wide variety of machine learning architectures. For example, with some embodiments, the architecture may involve the use of deep neural networks (e.g., Convolutional Neural Networks (CNNS), and so forth). Alternatively, the architecture may be based on some variety of decision tree model (e.g., Random Forest, XGBoost, etc.). And in other alternative embodiments, the architecture may involve a bilingual LSTM (Long Short Term Memory network,) or TextCNN (e.g., based on the Convolutional Neural Network for text).

Referring again to FIG. 5, after the intent classifier 502 has been trained, the intent classifier 502 is used to process a variety of input features derived from a content item 504 to predict the intent of an end-user who has posted the content item 504, or is in the process of posting the content item 504, to the feed. Accordingly, as illustrated with reference number 504, at inference time, the input to the model architecture 500 is a content posting 504 from the feed. The first step 506 in processing the content item 504 is to extract an image from the content posting, which is typically achieved by simply accessing an image file referenced in the content posting. Next, an OCR application is used to recognize text 508 within the image that has been extracted from the content item 504. With some embodiments, the text recognized during the OCR application may be further processed 510 to improve the text, for example, by identifying misspelled words and replacing those with the corrected spellings. Additionally, with some embodiments, the text may be analyzed by a named entity recognition model 512 to identify named entities — for example, names of people — occurring within the text. The text obtained from the image, and (optionally) corrected by the OCR text improvement model 510, and any named entities recognized within the text are provided as input features to the intent classifier 502.

In addition to processing the image extracted from the content item 504 to identify the text within the image, the image itself may be processed to derive various visual features for use as input to the intent classifier 502. Specifically, the image may be processed to determine the percentage of image area that is taken up by text, and/or the position of text within the image. Any number of other visual features (e.g., colors, number of colors, diversity of colors, objects identified, and so forth) may also be derived and provided as input to the intent classifier 502. For instance, visual features may include features derived from various pre-trained and fine-tuned models that are used to understand the image, such as Inception V3, EfficientNet, and/or ResNet 50. Additionally, a separate celebrity/author recognition model 516 may be used to analyze the image for the purpose of determining whether the image portrays a famous person to whom a quotation might be attributable. If recognized, the name of such person is provided as an input to the intent classifier 502.

Finally, in cases where the content item for which the intent is being predicted is one that has already been posted to the feed, any commentary that has been provided (e.g., using the comments feature of the various social gestures) may be analyzed and processed to derive features for providing as input to the intent classifier 502.

The intent classifier 502 processes the various input features to generate for each of several different intents, an intent score. For instance, with some embodiments, the intent score may be a value between zero and one, with zero indicating that there is little to no likelihood that the content poster had such an intent for the content posting, and one indicating a strong likelihood that the particular intent associated with the intent score was the content poster’s actual intent.

Consistent with some embodiments, each intent score associated with a different intent may be compared with a predetermined threshold to determine whether the particular intent of the content poster in posting the content item. If more than one intent score exceeds its corresponding threshold, then the status of the content item may be updated to reflect multiple intents, or, the intent with the highest intent score may be selected and used. If no intent score exceeds a corresponding threshold, the status of the content item may be updated to reflect that no intent could be interpreted, in which case, the content item may be marked as not suitable for presentation via the feed, or flagged for further analysis.

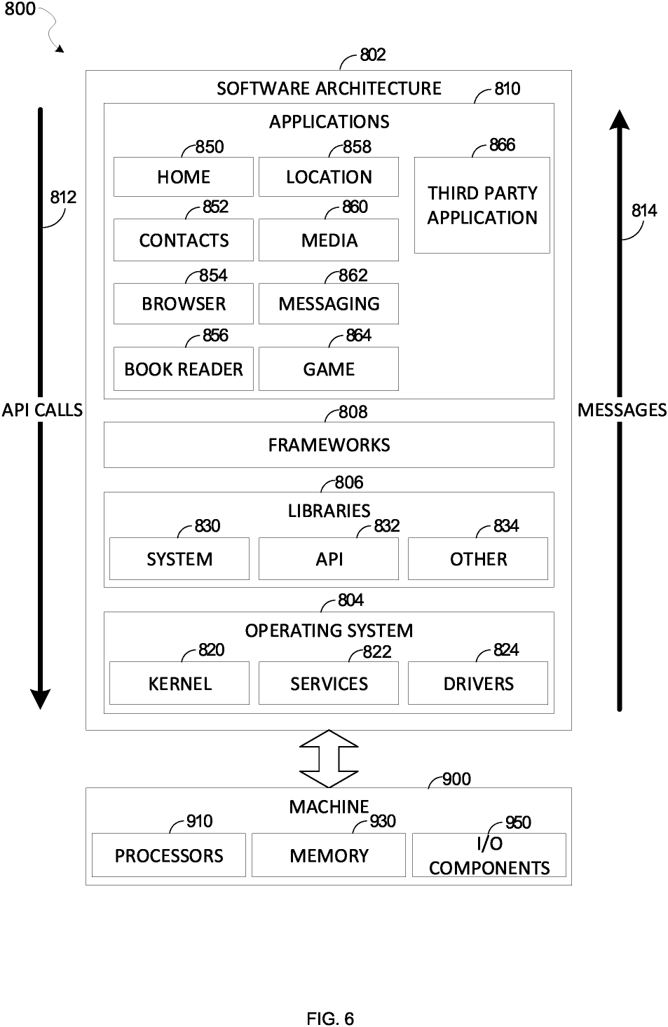

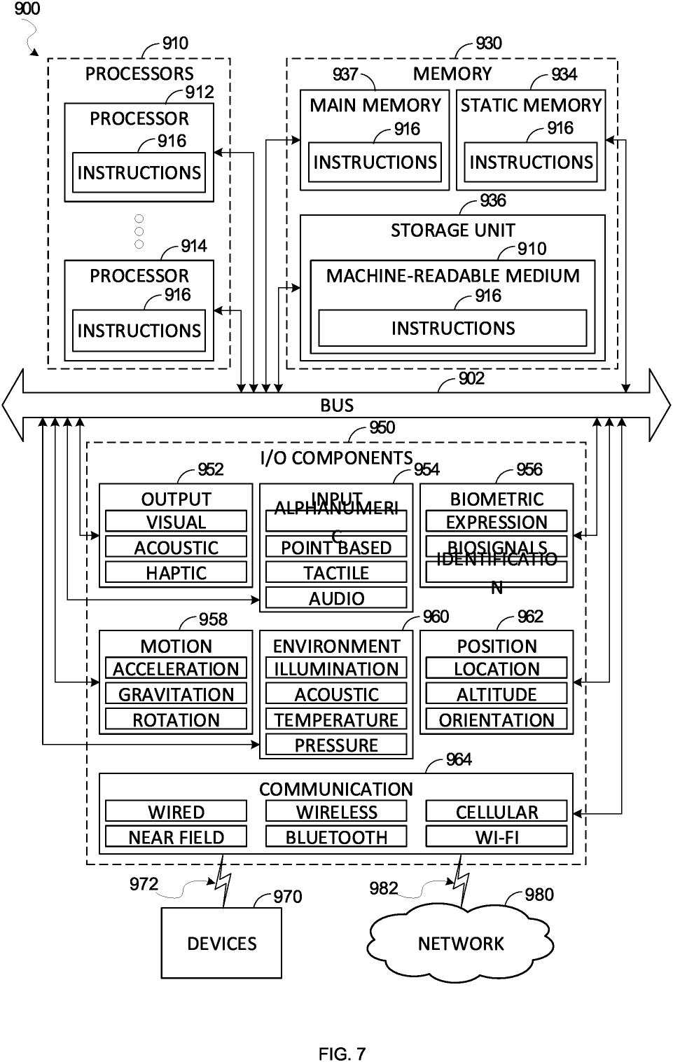

FIG. 6 is a block diagram 800 illustrating a software architecture 802, which can be installed on any of a variety of computing devices to perform methods consistent with those described herein. FIG. 6 is merely a non-limiting example of a software architecture, and it will be appreciated that many other architectures can be implemented to facilitate the functionality described herein. In various embodiments, the software architecture 802 is implemented by hardware such as a machine 900 of FIG. 7 that includes processors 910, memory 930, and input/output (I/O) components 950. In this example architecture, the software architecture 802 can be conceptualized as a stack of layers where each layer may provide a particular functionality. For example, the software architecture 802 includes layers such as an operating system 804, libraries 806, frameworks 808, and applications 810. Operationally, the applications 810 invoke API calls 812 through the software stack and receive messages 814 in response to the API calls 812, consistent with some embodiments.

In various implementations, the operating system 804 manages hardware resources and provides common services. The operating system 804 includes, for example, a kernel 820, services 822, and drivers 824. The kernel 820 acts as an abstraction layer between the hardware and the other software layers, consistent with some embodiments. For example, the kernel 820 provides memory management, processor management (e.g., scheduling), component management, networking, and security settings, among other functionality. The services 822 can provide other common services for the other software layers. The drivers 824 are responsible for controlling or interfacing with the underlying hardware, according to some embodiments. For instance, the drivers 824 can include display drivers, camera drivers, BLUETOOTH® or BLUETOOTH® Low Energy drivers, flash memory drivers, serial communication drivers (e.g., Universal Serial Bus (USB) drivers), Wi-Fi® drivers, audio drivers, power management drivers, and so forth.

In some embodiments, the libraries 806 provide a low-level common infrastructure utilized by the applications 810. The libraries 606 can include system libraries 830 (e.g., C standard library) that can provide functions such as memory allocation functions, string manipulation functions, mathematic functions, and the like. In addition, the libraries 806 can include API libraries 832 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 806 can also include a wide variety of other libraries 834 to provide many other APIs to the applications 810.

The frameworks 808 provide a high-level common infrastructure that can be utilized by the applications 810, according to some embodiments. For example, the frameworks 608 provide various GUI functions, high-level resource management, high-level location services, and so forth. The frameworks 808 can provide a broad spectrum of other APIs that can be utilized by the applications 810, some of which may be specific to a particular operating system 804 or platform.

In an example embodiment, the applications 810 include a home application 850, a contacts application 852, a browser application 854, a book reader application 856, a location application 858, a media application 860, a messaging application 862, a game application 864, and a broad assortment of other applications, such as a third-party application 866. According to some embodiments, the applications 810 are programs that execute functions defined in the programs. Various programming languages can be employed to create one or more of the applications 810, structured in a variety of manners, such as object-oriented programming languages (e.g., Objective-C, Java, or C++) or procedural programming languages (e.g., C or assembly language). In a specific example, the third-party application 866 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 866 can invoke the API calls 812 provided by the operating system 804 to facilitate functionality described herein.

FIG. 7 illustrates a diagrammatic representation of a machine 900 in the form of a computer system within which a set of instructions may be executed for causing the machine to perform any one or more of the methodologies discussed herein, according to an example embodiment. Specifically, FIG. 7 shows a diagrammatic representation of the machine 900 in the example form of a computer system, within which instructions 916 (e.g., software, a program, an application, an applet, an app, or other executable code) for causing the machine 900 to perform any one or more of the methodologies discussed herein may be executed. For example the instructions 916 may cause the machine 900 to execute any one of the methods or algorithms described herein. Additionally, or alternatively, the instructions 916 may implement a system or model as described in connection with FIGS. 3 and 5, and so forth. The instructions 916 transform the general, non-programmed machine 900 into a particular machine 900 programmed to carry out the described and illustrated functions in the manner described. In alternative embodiments, the machine 900 operates as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but not be limited to, a server computer, a client computer, a PC, a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 916, sequentially or otherwise, that specify actions to be taken by the machine 900. Further, while only a single machine 900 is illustrated, the term “machine” shall also be taken to include a collection of machines 900 that individually or jointly execute the instructions 916 to perform any one or more of the methodologies discussed herein.

The machine 900 may include processors 910, memory 930, and I/O components 950, which may be configured to communicate with each other such as via a bus 902. In an example embodiment, the processors 910 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 912 and a processor 914 that may execute the instructions 916. The term “processor” is intended to include multi-core processors that may comprise two or more independent processors (sometimes referred to as “cores”) that may execute instructions contemporaneously. Although FIG. 9 shows multiple processors 910, the machine 900 may include a single processor with a single core, a single processor with multiple cores (e.g., a multi-core processor), multiple processors with a single core, multiple processors with multiples cores, or any combination thereof.

The memory 930 may include a main memory 932, a static memory 934, and a storage unit 936, all accessible to the processors 910 such as via the bus 902. The main memory 930, the static memory 934, and storage unit 936 store the instructions 916 embodying any one or more of the methodologies or functions described herein. The instructions 916 may also reside, completely or partially, within the main memory 932, within the static memory 934, within the storage unit 936, within at least one of the processors 910 (e.g., within the processor’s cache memory), or any suitable combination thereof, during execution thereof by the machine 900.

The I/O components 950 may include a wide variety of components to receive input, provide output, produce output, transmit information, exchange information, capture measurements, and so on. The specific I/O components 950 that are included in a particular machine will depend on the type of machine. For example, portable machines such as mobile phones will likely include a touch input device or other such input mechanisms, while a headless server machine will likely not include such a touch input device. It will be appreciated that the I/O components 950 may include many other components that are not shown in FIG. 9. The I/O components 950 are grouped according to functionality merely for simplifying the following discussion and the grouping is in no way limiting. In various example embodiments, the I/O components 950 may include output components 952 and input components 954. The output components 952 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 954 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 950 may include biometric components 956, motion components 958, environmental components 960, or position components 962, among a wide array of other components. For example, the biometric components 956 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 758 may include acceleration sensor components (e.g., accelerometer), gravitation sensor components, rotation sensor components (e.g., gyroscope), and so forth. The environmental components 760 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 962 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 950 may include communication components 964 operable to couple the machine 900 to a network 980 or devices 970 via a coupling 982 and a coupling 972, respectively. For example, the communication components 964 may include a network interface component or another suitable device to interface with the network 980. In further examples, the communication components 964 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 970 may be another machine or any of a wide variety of peripheral devices (e.g., a peripheral device coupled via a USB).

Moreover, the communication components 964 may detect identifiers or include components operable to detect identifiers. For example, the communication components 964 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 764, such as location via Internet Protocol (IP) geolocation, location via Wi-Fi® signal triangulation, location via detecting an NFC beacon signal that may indicate a particular location, and so forth.

The various memories (i.e., 930, 932, 934, and/or memory of the processor(s) 910) and/or storage unit 936 may store one or more sets of instructions and data structures (e.g., software) embodying or utilized by any one or more of the methodologies or functions described herein. These instructions (e.g., the instructions 916), when executed by processor(s) 910, cause various operations to implement the disclosed embodiments.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 980 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 980 or a portion of the network 980 may include a wireless or cellular network, and the coupling 982 may be a Code Division Multiple Access (CDMA) connection, a Global System for Mobile communications (GSM) connection, or another type of cellular or wireless coupling. In this example, the coupling 982 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 916 may be transmitted or received over the network 980 using a transmission medium via a network interface device (e.g., a network interface component included in the communication components 964) and utilizing any one of a number of well-known transfer protocols (e.g., HTTP). Similarly, the instructions 916 may be transmitted or received using a transmission medium via the coupling 972 (e.g., a peer-to-peer coupling) to the devices 070. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 916 for execution by the machine 900, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

The terms “machine-readable medium,” “computer-readable medium” and “device-readable medium” mean the same thing and may be used interchangeably in this disclosure. The terms are defined to include both machine-storage media and transmission media. Thus, the terms include both storage devices/media and carrier waves/modulated data signals.

What is claimed is:

1. A computer-implemented method comprising:
for each quotation in a plurality of quotations comprising a collection of known quotations, using the words in the quotation to generate a vector representation of the quotation;
generating a search index for use with an approximate nearest neighbor search engine using the vector representations of the plurality of quotations;
receiving an image that has been posted, or has been submitted for posting, to a feed of an online service;
performing an optical character recognition operation on the image to recognize text within the image;
generating from the text recognized within the image a vector representation of the text;
providing the vector representation of the text recognized within the image as an input to an approximate nearest neighbor search engine, the approximate nearest neighbor search engine providing as output a match score based on determining a measure of distance between the vector representation of the text recognized within the image and a vector representation of a quote included in the search index; and
when the match score exceeds a first predetermined threshold, updating a status field associated with the image to indicate the image is acceptable for presentation via the feed.

2. The computer-implemented method of claim 1, further comprising:
prior to updating the status field associated with the image to indicate the image is acceptable for presentation via the feed when the match score exceeds the first predetermined threshold, calculating the edit distance between the characters of the words of the text recognized within the image and the characters of the words of the quotation from the search index having the vector representation on which the match score was determined.

3. The computer-implemented method of claim 1, further comprising:
analyzing the text recognized within the image to identify a name of a person; and
when the match score is less than the first predetermined threshold and the match score exceeds a second predetermined threshold, compare the name of the person identified in the text to a list of names of persons known to be associated with quotations in the plurality of quotations; and
when the name of the person identified in the text matches a name of a person in the list, updating a status field associated with the image to indicate the image is acceptable for presentation via the feed.

4. The computer-implemented method of claim 3, further comprising:
prior to updating the status field associated with the image to indicate the image is acceptable for presentation via the feed when the name of the person identified in the text matches a name of a person in the list, calculating the edit distance between the characters of the words of the text recognized within the image and the characters of the words of the quotation from the search index having the vector representation on which the match score was determined.

5. The computer-implemented method of claim 1, wherein using the words in the quotation to generate a vector representation of the quotation comprises:
converting all characters to lowercase; and
excluding any character other than an alphanumeric character.

6. The computer-implemented method of claim 1, wherein using the words in the quotation to generate a vector representation of the quotation comprises using only the words in the quotation that appear in any quotation in the collection of quotations with a frequency that exceeds a predetermined threshold.

7. The computer-implemented method of claim 1, wherein using the words in the quotation to generate a vector representation of the quotation comprises using the words in the quotation as input to a pre-trained Transformer encoder that derives as output the vector representation of the quotation.

8. The computer-implemented method of claim 1, wherein generating the search index using the vector representations of the plurality of quotations comprises arranging the vector representations of the plurality of quotations in a hierarchical, navigable, small world graph.

9. The computer-implemented method of claim 1, wherein updating the status field associated with the image to indicate the image is acceptable for presentation via the feed comprises:
updating the status field to indicate the image includes a quotation; and
prompting an end-user who is posting the image to include a metadata tag indicating that the image is a quotation.

10. A system comprising:
a memory device storing instructions; and
a processor, which, when executing the instructions, causes the system to:
for each quotation in a plurality of quotations comprising a collection of known quotations, use the words in the quotation to generate a vector representation of the quotation;
generate a search index for use with an approximate nearest neighbor search engine using the vector representations of the plurality of quotations;
receive an image that has been posted, or has been submitted for posting, to a feed of an online service;
perform an optical character recognition operation on the image to recognize text within the image;
generate from the text recognized within the image a vector representation of the text;
provide the vector representation of the text recognized within the image as an input to an approximate nearest neighbor search engine, the approximate nearest neighbor search engine providing as output a match score based on determining a measure of distance between the vector representation of the text recognized within the image and a vector representation of a quote included in the search index; and
when the match score exceeds a first predetermined threshold, update a status field associated with the image to indicate the image is acceptable for presentation via the feed.

11. The system of claim 10, comprising additional instructions, which, when executed by the processor, cause the system to:
prior to updating the status field associated with the image to indicate the image is acceptable for presentation via the feed when the match score exceeds the first predetermined threshold, calculate the edit distance between the characters of the words of the text recognized within the image and the characters of the words of the quotation from the search index having the vector representation on which the match score was determined.

12. The system of claim 10, comprising additional instructions, which, when executed by the processor, cause the system to:
analyze the text recognized within the image to identify a name of a person; and
when the match score is less than the first predetermined threshold and the match score exceeds a second predetermined threshold, compare the name of the person identified in the text to a list of names of persons known to be associated with quotations in the plurality of quotations; and
when the name of the person identified in the text matches a name of a person in the list, update a status field associated with the image to indicate the image is acceptable for presentation via the feed.

13. The system of claim 12, comprising additional instructions, which, when executed by the processor, cause the system to:
prior to updating the status field associated with the image to indicate the image is acceptable for presentation via the feed when the name of the person identified in the text matches a name of a person in the list, calculate the edit distance between the characters of the words of the text recognized within the image and the characters of the words of the quotation from the search index having the vector representation on which the match score was determined.

14. The system of claim 10, wherein using the words in the quotation to generate a vector representation of the quotation comprises:
converting all characters to lowercase; and
excluding any character other than an alphanumeric character.

15. The system of claim 10, wherein using the words in the quotation to generate a vector representation of the quotation comprises using only the words in the quotation that appear in any quotation in the collection of quotations with a frequency that exceeds a predetermined threshold.

16. The system of claim 10, wherein using the words in the quotation to generate a vector representation of the quotation comprises using the words in the quotation as input to a pre-trained Transformer encoder that derives as output the vector representation of the quotation.

17. The system of claim 10, wherein generating the search index using the vector representations of the plurality of quotations comprises arranging the vector representations of the plurality of quotations in a hierarchical, navigable, small world graph.

18. The system of claim 10, wherein updating the status field associated with the image to indicate the image is acceptable for presentation via the feed comprises:
updating the status field to indicate the image includes a quotation; and
prompting an end-user who is posting the image to include a metadata tag indicating that the image is a quotation.

19. A system comprising:
means for using the words in a quotation to generate a vector representation of the quotation, for each quotation in a plurality of quotations comprising a collection of known quotations;
means for generating a search index for use with an approximate nearest neighbor search engine using the vector representations of the plurality of quotations;
means for receiving an image that has been posted, or has been submitted for posting, to a feed of an online service;
means for performing an optical character recognition operation on the image to recognize text within the image;
means for generating from the text recognized within the image a vector representation of the text;
means for providing the vector representation of the text recognized within the image as an input to an approximate nearest neighbor search engine, the approximate nearest neighbor search engine providing as output a match score based on determining a measure of distance between the vector representation of the text recognized within the image and a vector representation of a quote included in the search index; and
means for updating a status field associated with the image to indicate the image is acceptable for presentation via the feed, when the match score exceeds a first predetermined threshold.

20. The system of claim 19, further comprising:
means for analyzing the text recognized within the image to identify a name of a person; and
means for comparing the name of the person identified in the text to a list of names of persons known to be associated with quotations in the plurality of quotations, when the match score is less than the first predetermined threshold and the match score exceeds a second predetermined threshold; and
means for updating a status field associated with the image to indicate the image is acceptable for presentation via the feed, when the name of the person identified in the text matches a name of a person in the list.
